(19) United States
(12) Patent Application Publication
(10) Pub. No.: US 2002/0194141 A1
(43) Pub. Date: Dec. 19, 2002

(54) Payment authorisation through beacons

(75) Inventors: Hubert Langensteiner, Mandelieu (FR); Paul J. Rankin, Horley (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/153,252

(22) Filed: May 22, 2002

(30) Foreign Application Priority Data
Jun. 5, 2001 (GB) 0113630.8

(51) Int. Cl. G06F 17/60

(52) U.S. Cl. 705/67

(57) ABSTRACT

An automated payment system comprises a data store (14) holding financial data of a user, A first (12) beacon device capable of wireless message transmission and at least one portable device (10) capable of receiving such message transmissions. The first beacon is arranged to broadcast a series of inquiry messages (1) according to a first communications protocol, such as Bluetooth. The portable device (10) detects such inquiry messages and replies (2) with an identifier for the portable device. The first beacon (12) then transmits (3) the received identifier to the data store (14), which in turn checks for a match between received and stored identifiers. On detection of a match, and following an optional credit check (3.A), a clearance signal (4) is sent to the first beacon (12) which then releases (5) the paid-for goods or services.

The present invention relates to the provision of goods or services offered to users of electronic equipment, especially but not exclusively to users of mobile communications devices such as portable telephones and suitably equipped PDA's (personal digital assistants) and more particularly to an arrangement for paying for such goods or services. The invention further relates to means for authorising delivery on payment for such goods or services.

Recent years have seen a great increase in subscribers world-wide to mobile telephone networks and, through advances in technology and the addition of functionalities, cellular telephones have become personal, trusted devices. A result of this is that a mobile information society is developing, with personalised and localised services becoming increasingly more important. Such “Context-Aware” (CA) mobile telephones are used with low power, short range base stations in places like shopping malls to provide location-specific information. This information might include local maps, information on nearby shops and restaurants and so on. Whilst such information will often be transmitted free of charge, there may be data services (for example an update to sports scores, the downloading of a new ringing tone for a mobile telephone) for which the user is charged. Whilst payment for such goods and services may be made by conventional methods, such as the sending of cheques or credit card authorisations, by tele-banking or direct debit arrangements, it has been recognised that a wireless-linked automated payment system could be beneficial to a user.

Wireless transactions at a distance (eg from a few meters) require special measures to capture the intent and consent of the user. These may entail the user memorising pin codes and unnecessary interaction effort in pushing buttons or typing numbers on their mobile device: such procedure is onerous for a small purchase. The transaction details themselves then need to be carried over a secure wireless network protocol.

It is therefore an object of the present invention to provide a means for authorising payments making use of the freedom given by wireless link and without the user having to undertake a lengthy or complex authorisation procedure.

In accordance with a first aspect of the present invention there is provided an automated payment system comprising a data store holding financial data of a user, a first beacon device capable of wireless message transmissions and at least one portable device capable of receiving such message transmissions, wherein said data store further holds an identifier associated with a portable device of said user, wherein said first beacon acts as a sales point for goods or services and is arranged to broadcast a series of inquiry messages over a short range and according to a first communications protocol, wherein said at least one portable device is arranged to detect such inquiry messages when within range and reply with an identifier for the portable device, wherein said first beacon device is arranged to transmit a received identifier to said data store, and wherein upon matching by said data store of a received and stored identifier, clearance is given for the release of said goods or services to the user. With the short range broadcast of inquiry messages, to obtain clearance for a purchase, the user need simply pass his/her portable device within the short range of the first beacon to trigger the clearance procedure.

The system may comprise a plurality of the first beacon devices distributed over a geographic area (e.g. a shopping mall) and linked—suitably via a secure data channel—to a common data store, with each beacon arranged to receive identifiers from a portable device and provide clearance for the release of respective goods or services.

The system may further comprise a second device operable to release said goods or services, coupled to communicate with a users portable device to establish the identity of the same, and arranged to obtain said clearance for that portable device from said data store prior to release of said goods or services. In such an arrangement, the second device may comprise one or more second beacon devices linked to the first beacon device and data store and operable to deliver data services to the portable device of a user following receipt of the identifier for that portable device from said first beacon device and receipt of the appropriate clearance from the data store.

The invention further provides a mobile communication device for use in the system recited above, the device comprising a receiver capable of receiving a short-range wireless inquiry message, processing means operable to process data contained within said message and compose a response message including an identifier for the device, and transmission means configured to wirelessly transmit said composed response message to the source of the inquiry message.

The invention yet further provides a communications infrastructure for use in the automated payment system recited above, the infrastructure comprising said data store and said first beacon device and an interconnection therebetween, said first beacon device being capable of wireless message transmission over a short distance and to said at least one portable device, wherein said first beacon is operable to broadcast said series of inquiry messages according to a first communications protocol, to detect any response messages containing a portable device identifier for said portable device, and to transmit a received identifier to said data store, and wherein said data store is configured to perform a comparison between a received identifier for said portable device and a stored identifier for the user and, upon detection of a match, to give clearance for the release of goods or services to the same.

Also in accordance with the present invention there is provided a method for enabling the user of a portable communications device to purchase goods or services through a service interaction with a beacon device in an environment containing at least a data store holding financial data of a user and a first beacon device capable of wireless message transmission, wherein a first beacon broadcasts a series of inquiry messages over a short distance and according to a first communications protocol, the users portable device detects such inquiry messages and replies with an identifier for the portable device, the first beacon device transmits a received identifier to said data store and, upon matching by said data store of a receiver and stored identifier, clearance is given for the release of goods or services to a user. The data store may further hold a financial balance for a user, from which balance a predetermined cost for respective goods or services is deducted prior to clearance being given for their release, optionally with clearance being withheld if, at any time, a current balance is insufficient to meet the cost of a requested item of goods or services.

To avoid erroneous clearances, or possible misappropriation, the method may comprise the further step of determining that there are no similarly configured portable devices communicating with the first beacon device during the obtaining of clearance and prior to the release of said goods or services: the step of determining may require the user to keep their portable device within communications range of the first beacon for a predetermined period.

For enhanced user-friendliness, the method may further comprise the step of enabling user-selection from a menu of available goods or services prior to obtaining clearance for the release of the user-selected item of goods or services.

Further features and advantages of the present invention are recited in the attached claims, the disclosure of which is incorporated herein by reference, and to which the reader is now directed.

Preferred embodiments of the invention will now be described, by way of example only, and with reference to the accompanying drawings, in which:

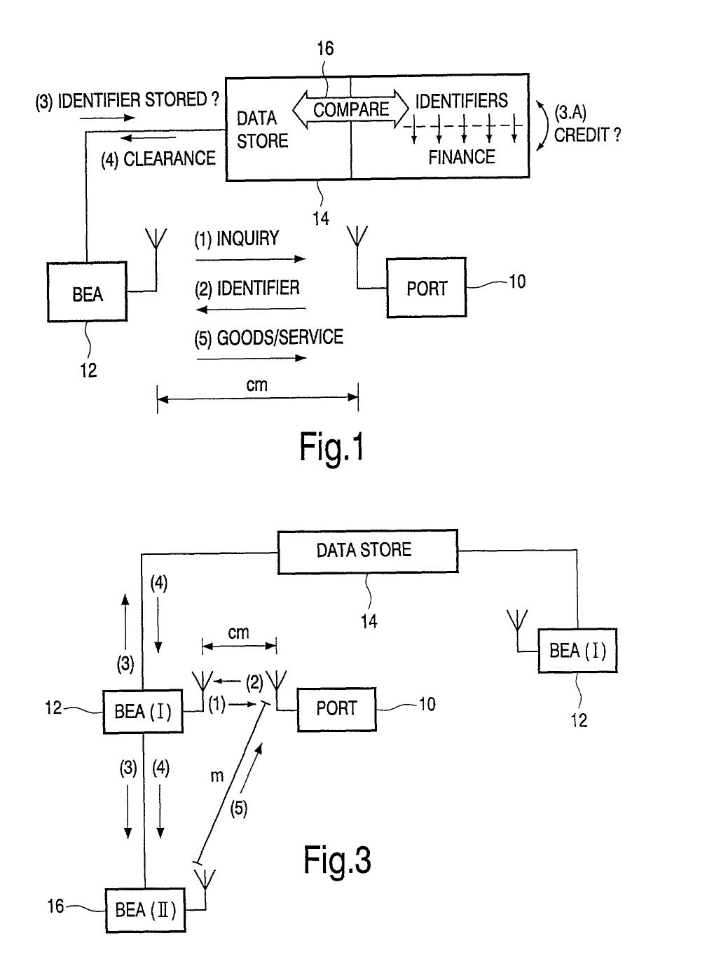

FIG. 1 is a block schematic diagram of a beacon, data store, and portable device embodying the invention;

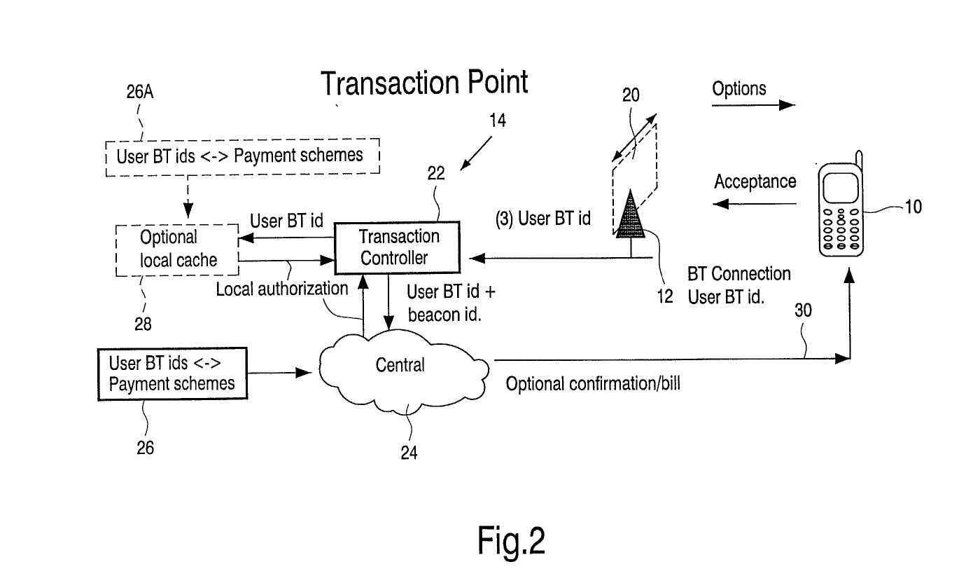

FIG. 2 shows in greater detail some features of the embodiment of FIG. 1; and

FIG. 3 represents a variant on the system of FIG. 1 utilising multiple beacons.

In the following description we consider particularly a CA application which utilises Bluetooth protocols for communication of messages from beacon to portable device (whether telephone, PDA or other). As will be recognised, the general invention is not restricted to Bluetooth devices, and is applicable to other communications arrangements.

FIG. 1 shows in generalised form the component features of an automated payment system, comprising a data store 14 holding financial data of a user, a first 12 beacon device capable of wireless message transmission and at least one portable device 10 capable of receiving such message transmissions. The figure illustrates, by the numbers in parentheses, the sequence of message transmission The first beacon is arranged to broadcast a series of inquiry messages (1) according to a first communications protocol, such as Bluetooth. The portable device 10 detects such inquiry messages and replies (2) with an identifier for the portable device. The first beacon 12 then transmits (3) the received identifier to the data store 14, which in turn checks 16 for a match between received and stored identifiers. On detection of a match, and following an optional credit check (3.A), a clearance signal (4) is sent to the first beacon 12 which then releases (5) the paid-for goods or services. Such an arrangement may be used in places like shopping malls to vend location-specific information such as local maps, access to local clubs and so on, with a beacon downloading the data to the mobile device, or otherwise making available (for example via a mechanical dispenser) a product so purchased.

FIG. 2 presents an embodiment of the generic system of FIG. 1 in more detail and with additional features. As shown, mobile telephone 10 is the mechanism by which the user authorises payment, with purchase options being initially offered to the user via a screen or audio menu 20 associated with the beacon 12 in the form of a Bluetooth access point.

For many simple transactions, the user device 10 can get into very close proximity with the fixed, transaction access-point 12. The range of a Bluetooth Access Point can be reduced to 1-2 cm by adjusting the transmission power of its Bluetooth radio. The access point can then continuously perform just the Bluetooth Inquiry scanning function, discovering the BT_ADDR's of any mobile device which has deliberately been held for a given number of seconds (e.g. 3) within the range of the access point ‘reader’ by its user. The mobile's BT_ADDR device id is then passed over a fast back-end (fixed line, GPRS/GSM call etc) to a transaction controller 22 forming a part of the transaction point or data store 12. From the transaction controller 22, the BT_ADDR device id is passed to a central system 24 for its validation against a database 26 of those mobile device Identifiers which have user-registered payment methods enabled (e.g. phone bills, credit cards.). In case of a slow back-end, it may be necessary for the transaction controller 22 to maintain a regularly-updated, local cache 28 holding a copy 26.A of this payment authorisation database. From the central system 24, a confirmation of a payment (or a bill to be paid) may be sent over e.g. WAN 30 to the mobile device 10.

The system therefore provides a natural, very easy-to-use and explicit solution for purchases with a user's mobile Bluetooth-enabled device. Any Bluetooth devices can be used in this fashion, as they all have unique Bluetooth Identifiers: operation is as simple and positive an action as using a credit card swipe. As will be recognised, the same mechanism may be implemented using other RF standards that entail unique RF device Identifiers, for example, 802.11, PurINet/Lite with a reduced-range.

As mentioned, more than one beacon may be part of the system. A shopping mall might place one at each entrance to the building, or within each retail unit to permit the purchase of goods or services therein. FIG. 3 illustrates some options for extending the general scheme, with a second instance of the first beacon type 12 connected to the same data store, as well as a second beacon type 16 coupled with a first. With this second beacon type, the duration of interactions between the mobile 10 and the payment authorising beacon 12 may be kept short, with the service interaction for the delivery of services or enabling of access to purchased goods being handled at beacon 16. As indicated by the lines respectively marked “cm” and “m” in the Figure, the second beacon may be a much higher powered device having a far greater broadcast range than the first beacon 12, such that a user is not then required to hold the mobile in such close proximity to a beacon in order to conclude the transaction.

The idea of using the short(cm)-range Bluetooth-readers for small payments has very wide application, such as payment for entry fees, purchasing soft drinks from vending machines, payment of phone charges, purchase of train tickets and so forth, all of which may be charged back to a users telephone bill or a pre-registered credit card. For larger payments with a corresponding higher risk, then more sophisticated security measures than just sole reliance on a Bluetooth device address may be applied, for example the exchange of digital certificates, private/public key encryption methods and so forth.

The system is very easy to use: a user need only hold the mobile 10 under the Bluetooth reader (or other form of first beacon) for a few seconds (no number entry or secure transaction protocol being required) after pressing the Brand X selection on a vending machine. The vending machine sends back to the central authorisation system (via secure GPRS or any other transaction back-end system) the users Bluetooth Identifier for debiting. After registering a transaction, the access point should provide feedback (audibly or visually) to the user to indicate the completion of the process. Feedback may be direct from the access point, or to the mobile (via wide-area network—line 30; FIG. 2—or Bluetooth). A time delay may be deliberately inserted, or a pause added until the regular Inquiry polling has discovered an absence of any Bluetooth device in proximity, before the access point is activated again to accept another mobile device for payment.

The user must have pre-registered their Bluetooth device Identifier for use as a payment device and authorised a payment scheme (credit card number, associated telephone number for billing back against their telephone bill etc) to which it is correlated in a central database. Protections can be added, for example to limit the maximum expenditure using the Bluetooth device Identifier as authorisation within a given period, to limit the maximum number of repeated payments of same type or maximum number at the same transaction device, to stop transactions with stolen mobile devices (perhaps noting their currently-detected access-point location) and so on.

The main advantage for the user is the natural simplicity and transparency of this physical purchase action. Savings can also made on the system side in reducing unnecessary Bluetooth secure protocol handling, with the corresponding reduction of wasted radio spectrum usage.

From reading the present disclosure, other modifications will be apparent to persons skilled in the art. Such modifications may involve other features which are already known in the design, manufacture and use of fixed and portable communications systems, and systems and components for incorporation therein and which may be used instead of or in addition to features already described herein.

1. An automated payment system comprising a data store holding financial data of a user, a first beacon device capable of wireless message transmissions and at least one portable device capable of receiving such message transmissions, wherein said data store further holds an identifier associated with a portable device of said user, wherein said first beacon acts as a sales point for goods or services and is arranged to broadcast a series of inquiry messages over a short range and according to a first communications protocol, wherein said at least one portable device is arranged to detect such inquiry messages when within range and reply with an identifier for the portable device, wherein said first beacon device is arranged to transmit a received identifier to said data store, and wherein upon matching by said data store of a received and stored identifier, clearance is given for the release of said goods or services to the user.

2. A system as claimed in claim 1, comprising a plurality of first beacon devices distributed over a geographic area and linked to a common data store, and each arranged to receive identifiers from a portable device and provide clearance for the release of respective goods or services.

3. A system as claimed in claim 1, further comprising a secure data channel linking said first beacon device and data store for the transmission of received identifiers.

4. A system as claimed in claim 1, further comprising a second device operable to release said goods or services, coupled to communicate with a users portable device to establish the identity of the same, and arranged to obtain said clearance for that portable device from said data store prior to release of said goods or services.

5. A system as claimed in claim 4, wherein said second device comprises one or more second beacon devices linked to said first beacon device and said data store and operable to deliver data services to the portable device of a user following receipt of the identifier for that portable device from said first beacon device and receipt of said clearance from said data store.

6. A system as claimed in claim 1, wherein said first communications protocol comprises Bluetooth messaging and wherein the first beacon device is configured to broadcast a series of inquiry messages on a predetermined clocked succession of frequencies, with clock information for said first beacon device being included in data carried by said additional data field.

7. A mobile communication device for use in the system of claim 1, the device comprising a receiver capable of receiving a short-range wireless inquiry message, processing means operable to process data contained within said message and compose a response message including an identifier for the device, and transmission means configured to wirelessly transmit said composed response message to the source of the inquiry message.

8. A communications infrastructure for use in the automated payment system of claim 1, the infrastructure comprising said data store and said first beacon device and an interconnection therebetween, said first beacon device being capable of wireless message transmission over a short distance and to said at least one portable device, wherein said first beacon is operable to broadcast said series of inquiry messages according to a first communications protocol, to detect any response messages containing a portable device identifier for said portable device, and to transmit a received identifier to said data store, and wherein said data store is configured to perform a comparison between a received identifier for said portable device and a stored identifier for the user and, upon detection of a match, to give clearance for the release of goods or services to the same.

9. A communications infrastructure as claimed in claim 8, wherein said interconnection between the first beacon device and data store comprises a secure data channel.

10. A communications infrastructure as claimed in claim 8, further comprising a plurality of first beacon devices linked to a common data store.

11. A method for enabling the user of a portable communications device to purchase goods or services through a service interaction with a beacon device in an environment containing at least a data store holding financial data of a user and a first beacon device capable of wireless message transmission, wherein a first beacon broadcasts a series of inquiry messages over a short distance and according to a first communications protocol, the users portable device detects such inquiry messages and replies with an identifier for the portable device, the first beacon device transmits a received identifier to said data store and, upon matching by said data store of a receiver and stored identifier, clearance is given for the release of goods or services to a user.

12. A method as claimed in claim 11, wherein the data store further holds a financial balance for a user, from which balance a predetermined cost for respective goods or services is deducted prior to clearance being given for their release.

13. A method as claimed in claim 12, wherein clearance is not given if, at any time, a current balance is insufficient to meet the cost of a requested item of goods or services.

14. A method as claimed in claim 11, further comprising the step of determining that there are no similarly configured portable devices communicating with the first beacon device during the obtaining of clearance and prior to the release of said goods or services.

15. A method as claimed in claim 14, wherein the step of determining requires the user to keep their portable device within communications range of said first beacon for a predetermined period.

16. A method as claimed in claim 11, further comprising the step of enabling user-selection from a menu of available goods or services prior to obtaining clearance for the release of the user-selected item of goods or services.

17. A method as claimed in claim 11, wherein said short distance is less than 1 meter.

18. A method as claimed in claim 11, wherein said short distance is less than 5 centimeters.
